(19) United States
(12) Patent Application Publication
(10) Pub. No.: US 2024/0103483 A1
(43) Pub. Date: Mar. 28, 2024

(54) METHOD AND SYSTEMS FOR VALIDATING INDUSTRIAL MACHINE SYSTEMS

(71) Applicant: Siemens Aktiengesellschaft, 80333 München (DE)

(72) Inventors: ULRICH BUNGERT, Berg (DE); JÜRGEN GOHLA, Wiesenthau (DE); DIETER RUPP, Wilhelmsdorf (DE)

(73) Assignee: Siemens Aktiengesellschaft, 80333 München (DE)

(21) Appl. No.: 18/038,144

(22) PCT Filed: Nov. 15, 2021
(86) PCT No.: PCT/EP2021/081613

§ 371 Date: May 22, 2023

(30) Foreign Application Priority Data
Nov. 23, 2020 (EP) 20209192.2

(51) Int. Cl. G05B 19/406

(52) U.S. Cl. CPC G05B 19/406; G05B 2219/50193

(57) ABSTRACT

A method checks an industrial machine or an automation system by a computer-assisted safety test. At least one control path of the entire industrial machine or of the entire automation system is checked the computer-assisted safety test.

The invention relates to a method, in which an industrial machine or an automation installation is checked or validated by means of a computer-assisted safety test.

Moreover, the invention relates to a computer program comprising commands, which, when the computer program is executed by an engineering platform, trigger this to carry out the afore-cited method.

Finally, the invention relates to a machine-readable data medium and a data stream with the afore-cited computer program. Here the computer program can exist in encrypted and/or compressed form, for instance.

Moreover, the invention relates to an engineering platform, comprising the afore-cited computer program.

The method of the type cited in the introduction, in other words the safety tests for industrial machines or automation installations in the field of automation technology, are known from the prior art. For instance, US 2004/0153788 A1 shows a method, in which individual components of an industrial machine can be checked. The computer-assisted safety test is designed here as a wizard which runs on an engineering platform. The disadvantage with the method known from the prior art is that within the scope of machine validation using such safety tests, only specific, individual components, for instance drives, of the machine can be validated.

The object of the present invention can thus be seen to be to provide methods and systems, in particular in the form of engineering platforms, which overcome the afore-cited disadvantage.

The object of the invention is achieved in accordance with the invention with a method cited in the introduction so that with the computer-assisted safety test, at least one control path of the entire industrial machine or the entire automation installation is checked.

The invention makes possible a function test of the safety functions of the industrial machine or the automation installation, for instance.

In one embodiment, provision can be made for the computer-assisted safety test to determine, preferably automatically, the at least one control path from available data relating to the industrial machine or the automation installation, and to generate a test specification or a description of a test case for the determined at least one control path from this data, According to this specification, the safety test can be carried out.

Moreover, provision can be made for a number of control paths to be determined and for a test specification or a description of a test case to be generated for each control path.

The available data which is relevant to the description of the test case or the test cases can be read out and preferably visualized for instance from machine signals and/or states which are available in the control and drive systems.

In one embodiment, provision can advantageously be made for the computer-assisted safety test to automatically carry out the check of the at least one control path.

In one embodiment, it may be expedient if the at least one control path begins with a sensor facility and ends with a reaction component and individual physical and/or data engineering interfaces are checked when the at least one control path is checked. This is advantageous in that with the safety test interfaces of the automation and drive components in the machine/installation can be included in the validation and validated.

In one embodiment, provision can be made for the sensor facility to have an emergency off switch and/or an emergency stop button and/or a safety position switch and/or one or more technical sensors or measuring sensors and/or a sensor switch, for instance a switch which responds to touch.

In one embodiment, it may be expedient if, with the computer-assisted safety test
for the check of the at least one control path, a corresponding initial state of the industrial machine or the automation installation is defined and a corresponding test run is fixed,
the industrial machine or the automation installation is moved or transferred into the initial state and during this is monitored,
starting from the initial state, the test run is carried out, wherein the industrial machine or the automation installation is monitored during the test run.

The test run can comprise one or more test steps, in which handling instructions and reactions to be expected from the industrial machine or the automation installation are described.

The method described above provides for the transfer of the test case descriptions (initial state, test run) to other industrial machines/automation installations for reusability.

In one embodiment, provision can be made during the monitoring process to test whether one or more reactions of the industrial machine or the automation installation to action step(s) match with one/more reaction/s to be expected.

The term “reaction to an action step to be expected” is understood in connection with the present invention to mean a behavior of the industrial machine or the automation installation which is caused by performing the action step, which the industrial machine or the automation installation must show so that a partial test which corresponds to the action step can be completed successfully.

In other words, in order to carry out a test, a number of partial tests may be required, wherein each partial test is performed by an action step. Each of the action steps results in a partial result, which can be considered to be a result of the partial test.

In this respect it may be advantageous that during the entire test run, data which is relevant to the test run, states of the industrial machine or of the automation installation, implemented action steps and reactions of the industrial machine or the automation installation to the implemented action steps are monitored and are preferably documented.

It may be particularly useful if prescribed action steps, which were not actually performed, and/or unachieved states of the manufacturing installation are identified in the computer program and documented.

In one embodiment, provision can be made for the computer-assisted safety test to further comprise an acceptance test, during which at least one safety function and/or one safety subfunction is checked.

In one embodiment, it may be advantageous if the industrial machine or the automation installation is present in the form of a simulation, a digital image of a real industrial machine or the automation installation, in particular in the form of a digital twin.

In one embodiment, provision can be made for the computer-assisted safety test to be carried out by an operator or automatically.

The afore-cited object is also achieved in accordance with the invention with a computer program, in that the program comprises commands, which, when the computer program is executed by a computer connected to the industrial machine or to the automation installation, enables or triggers this to carry out the afore-cited method. The computer program can be stored on a laptop or tablet, for instance.

The method can be implemented on the different platforms (engineering platforms, HMI).

In summary, the method described above offers a generic description of test cases. A test case can comprise input conditions, handling instructions and reactions. The implementation of these (different) test cases (with different test runs) can take place on the machine or on the automation installation manually by a user or by means of a software-based automated sequence.

The data which is relevant to the description of the test cases can be read out from machine signals and/or states which are available in the control and drive systems and preferably visualized for instance. The reaction of the industrial machine or the automation installation defines the specific and detailed behavior which the industrial machine or the automation installation has to assume during the test run so that the test can be completed successfully.

The implementation of the safety test with a computer program offers the user a simple implementation of the test cases on the basis of assistants. The assistants can be generated for instance automatically from the test case description and within the scope of the test implementation can access the data and states of the industrial machine or the automation installation (available in the control and drive systems). In addition to this manual implementation, the method also provides, as already described, the automation of the test cases, which can therefore automatically run on a controller, for instance.

On the one hand the method enables a higher transparency during the validation of the industrial machine or the automation installations, particularly during the validation of its wiring. On the other hand, the method can significantly reduce the time and effort that a machine manufacturer requires for process creation for the tests and for a manual description, implementation and documentation of the test steps.

The invention is described and explained in greater detail below on the basis of the exemplary embodiments represented in the figures. In the drawings:

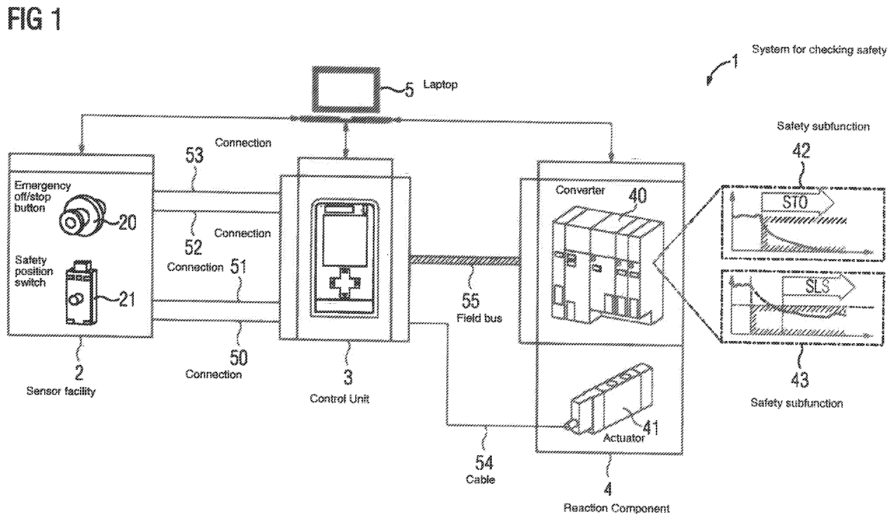

FIG. 1 shows a system for checking the safety of a manufacturing installation, and

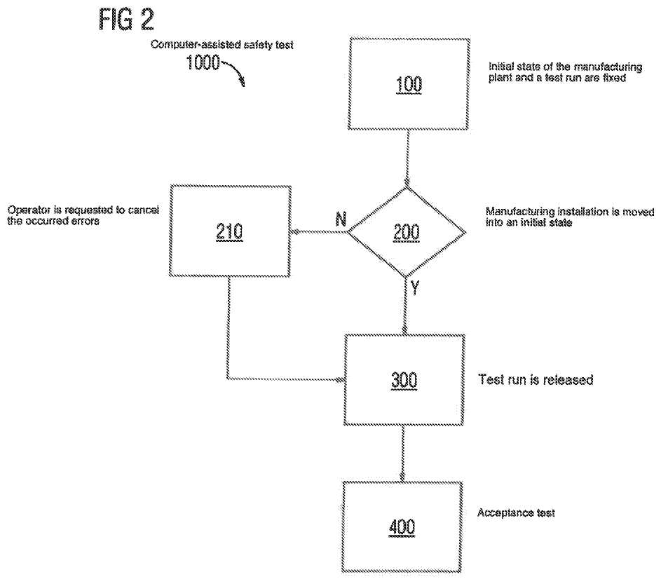

FIG. 2 shows a flow chart of an exemplary embodiment of a validation procedure of a manufacturing installation.

In the exemplary embodiments and figures, the same or similarly acting elements can each be provided with the same reference signs. Moreover, the reference signs in the claims and in the description are only used for an improved understanding of the present application and should in no way be considered to restrict the subject matter of the present invention.

Reference is made firstly to FIG. 1. This shows a system 1 for checking the safety of a manufacturing installation, Systems for checking the safety of industrial machines, for instance machine tools, or automation installations, for instance manufacturing installations, have a functionality which typically comprises three functions: detection, evaluation and reaction. Each function can be implementable for instance by means of a hardware or software component, wherein the hardware and/or software components interact with one another in order to enable the functionality of the safety system. The three components can be embodied structurally separately from one another and/or have user interfaces.

The system 1 can be embodied as an engineering platform or as part of an engineering platform. One example of an engineering platform is TIA (Totally Integrated Automation) Portal.

The interaction of the individual components is enabled by connecting the components for one-sided or two-sided information and/or signal exchange. The components can be cable-bound, for instance. The components can also be connected by way of radio.

The system 1 shown in FIG. 1 comprises a sensor facility 2 (detection), a control unit 3 (evaluation) and a reaction component 4 (reaction).

The sensor facility 2 has an emergency off button or emergency stop button 20 of a machine tool (not shown here) and a safety position switch 21, which can be arranged on a production line (not shown here), The sensor facility 2 can also comprise one or more sensors of another type. The individual sensors can also be embodied as technical sensors or measuring sensors or as sensor switches, for instance like the afore-cited switches 20 which respond to touch.

The sensor facility 2 is connected to the control unit 3 by means of connections 50, 51, 52, 53. The data connections can for instance as a cable (in this case reference is made to a wiring between the sensor facility 2 and the control unit 3) or as a databus system (e.g. a field bus). The control unit 3 evaluates signals received by the sensor facility 2, for instance from the emergency off button or emergency stop button 20 or from the safety position switch 21 and sends corresponding signals/commands, for instance via further connections to the reaction component 4, in order to control the machine tool and or the production line by way of the reaction component 4. The further connections can likewise be embodied as a cable 54 (digital outputs of the control unit 3) or as a field bus 55.

The control unit 3 can transmit the results of the evaluation to the reaction component in the form of cyclical telegrams, for instance. For instance, the evaluation component can be equipped with a preferably error-free functioning evaluation computer program for evaluating the signals received from the detection component and preferably have a user interface equipped with an operator interface.

The reaction component 4 comprises a drive unit embodied as a converter 40 and an actuator 41, which can be embodied as a directional valve, for instance. The actuator 41 can be designed for instance to hydraulically or pneumatically drive one or more machine components of the machine tool (not shown here), for instance. The converter 40 can be embodied as a frequency converter, for instance. The converter 40 can be provided to drive the parts or the entire machine tool of the production line or another part or another component of the manufacturing installation.

Overall, FIG. 1 allows a number of control paths to be identified, by way of which the safety-relevant signals can be transmitted from the sensor facility 2 to the reaction component 4, E.g. the connections 52 and 53 form a part of a logical, preferably failsafe control path. The connections 50, 51 likewise form a part of a logical, preferably failsafe control path. Each control path begins in a sensor 20, 21 of the sensor facility 2 and ends in a converter 40 or an actuator 41. This therefore involves control paths of the overall manufacturing installation.

The converter 40 can be embodied for instance as a supply unit for a drive (not shown here), for instance a feed drive or a main drive of a machine tool.

The actuator 41 can be embodied as a pneumatic or hydraulic actuator, auxiliary drive etc., for instance.

Before the manufacturing installation can be put into operation, the system 1 is tested by means of a computer-assisted safety test, wherein at least one of the afore-cited control paths is checked in the case of the safety test. The computer-assisted safety test is a safety test which is carried out with the aid of a computer program.

When checking the control path or the control paths, individual physical and/or data engineering interfaces, for instance individual connections 50 to 55, can be tested.

By means of such a test of individual data points, the entire signal path can be spanned from the sensor 20, 21 to the converter 40 or actuator 41 and thus included in the test. A test of the entire manufacturing installation, a wiring test, is thus carried out.

FIG. 2 shows a flow diagram of an exemplary embodiment of the computer-assisted safety test 1000, in which at least one control path is checked. To this end, the computer-assisted safety test 1000 can determine the control path, preferably automatically, from available data relating to the industrial machine or to the automation installation and generate a test specification for the determined at least one control path. The control path can be checked by the computer-assisted safety test 1000 and preferably on the basis of the test specifications.

Firstly, step 100, an initial state of the (entire) manufacturing plant and a test run can be fixed for checking the at least one control path. In other words, it may be expedient to check a specific control path on the basis of a specific, corresponding initial state and according to a specific test run.

This can take place by means of an operator, for instance, who defines an initial state in the computer program and fixes a test run for checking a specific control path.

Then, step 200, the manufacturing installation is moved into the initial state. The initial state can prescribe, for instance, that the actuator 41 (e.g. an axis) is to be moved into a defined position. The movement of the manufacturing installation into the predefined state is monitored with the computer-assisted safety test. This ensures that this action, the movement, is carried out correctly or in accordance with the regulations, by a check being carried out to determine whether the manufacturing installation reacts to actions to be carried out upon moving into the initial state, i.e. the reaction of the manufacturing installation to the actions of the reaction to be expected. If no errors occur when the manufacturing installation is moved into the initial state, the (further) test run is released—arrow Y.

If when the manufacturing installation is moved into the initial state, its reaction does not correspond to the reaction to be expected—arrow N (the actuator 41 remains still or is not moved into the defined position, for instance), the computer program can output a warning message and request the operator to cancel the occurred error or errors—step 210. Since the error or errors was or were canceled and the defined initial state was reached, the further test run is released. It is also conceivable for the computer program to cancel the error automatically/on its own and preferably to document this. The latter may in particular be the case if the manufacturing installation is embodied as a digital twin, i.e. a digital image of a real manufacturing installation.

Because the (defined) initial state, either without errors or because all errors are canceled, is reached, the further sequence of the test is released.

The test run can comprise a description of actions to be carried out and reactions of the manufacturing installation to be expected. In other words, during a computer-assisted safety test an operator can be guided through the test by the computer program, by the operator receiving handling instructions.

In this case, during the entire run, data relevant to the test run, states of the manufacturing installation, for instance action steps performed by the operator and reactions of the manufacturing installation to the performed action steps can be monitored and preferably documented. It may be particularly useful if prescribed action steps, which were not actually performed, and/or unachieved states of the manufacturing installation are identified in the computer program and documented.

With each implemented action, the reaction of the manufacturing installation to this action can be compared with a reaction to be expected, for instance.

With the further test run, it is possible to check whether the converter 40 carries out one or more safety subfunctions 42, 43 in response to a signal emanating from the sensor 20, 21, without these safety subfunctions 42, 43 having to be checked themselves.

Each drive unit comprises at least one safety function. This at least one safety function is integrated into each drive unit. The term “safety function” is known sufficiently in the field of functional safety. A safety function comprises (all) safety subfunctions from sensor to actuator or as far as the drive/converter.

A non-exhaustive list of safety functions is: STO (Safe torque off); SS1 (Safe stop 1); SS2 (Safe stop 2); SOS (Safe operating stop); SLS (Safely-limited speed); SSM (Safe speed monitor); SSR (Safe speed range); SLP (Safely-limited position); SDI (Safe direction), The aforementioned safety subfunctions are contained in DIN EN 61800-5-2 for instance. Further safety subfunctions are SP (Safe position); SBC/SBT (Safe brake control, Safe brake test) for instance.

Furthermore, the safety test can comprise an acceptance test, with which the correctness of the execution of at least one of the safety subfunctions 42, 43 is checked—step 400.

Acceptance test is also known as configuration test (IEC 61800-5-2) or safety acceptance test. One or more of the subsequent steps can be carried out during an acceptance test:
checking one or more safety functions for correct parameterization;
implementing a plausibility check of the (projected) safety functions by measuring reaction times and/or observing the stop reactions in the case of limit value infringements;
documenting the parameterized safety functions.

The aforementioned computer program can be stored in an executable manner on a computer-readable data medium, for instance. The data medium can be as a hard disk of a laptop 5, in other words of a portable computer, for instance. The laptop 5 can be connected to the aforementioned engineering platform or be a part thereof, for instance.

The laptop 5 with the computer program installed thereupon can be connected to the system 1 of a real manufacturing installation for the purpose of implementing the safety test or connected to its digital image.

Although the invention has been illustrated and described in detail with exemplary embodiments, the invention is not restricted by the examples disclosed. Variations thereof can be derived by a person skilled in the art without departing from the scope of protection of the invention as defined by the following claims. In particular, the features described in connection with the method (FIG. 2) can also be used or complete this in the case of the system (FIG. 1) and vice versa.

What is claimed:

1.-14. (canceled)

15. A method, comprising:
checking an industrial machine, wherein the industrial machine is embodied as a machine tool, or an automation installation embodied as a manufacturing installation, with a computer-assisted safety test, wherein the computer-assisted safety test comprises an acceptance test;
checking at least one safety function and/or one safety subfunction with the acceptance test;
checking at least one control path of the entire machine tool or the entire manufacturing installation with the computer-assisted safety test, wherein the at least one control path of the entire machine tool or the entire manufacturing installation begins with a sensor facility, which comprises an emergency off button or an emergency stop button of the machine tool and/or a safety position switch arranged on a production line, and ends with a reaction component; and checking individual physical and/or data engineering interfaces when the at least one control path is checked.

16. The method of claim 15, further comprising:
determining the at least one control path from available data relating to the industrial machine or the automation installation with the computer-assisted safety test; and
generating a test specification for the determined at least one control path.

17. The method of claim 16, wherein the at least one control path is automatically determined with the computer-assisted safety test.

18. The method of claim 15, wherein the computer-assisted safety test carries out the check of the at least one control path automatically.

19. The method of claim 15, wherein the sensor facility has one or more technical sensors or measuring sensors and/or a sensor switch, for instance a switch which responds to touch.

20. The method of claim 19, wherein the sensor switch is a switch which responds to touch.

21. The method of claim 15, further comprising:
defining with the computer-assisted safety test a corresponding initial state of the industrial machine or the automation installation for the checking of the at least one control path;
Fixing with the computer-assisted safety test a corresponding test run;
moving with the computer-assisted safety test the industrial machine or the automation installation into the initial state;
monitoring with the computer-assisted safety test the industrial machine or the automation installation during the moving into the initial state;
carrying out with the computer-assisted safety test the test run starting from the initial state; and
monitoring with the computer-assisted safety test the industrial machine or the automation installation during the test run.

22. The method of claim 21, further comprising monitoring during the entire test run, data relevant to the test run, states of the industrial machine or the automation installation, implemented action steps and reactions of the industrial machine or the automation installation to the implemented action steps.

23. The method of claim 22, further comprising documenting the data.

24. The method of claim 15, wherein the industrial machine or the automation installation is present in the form of a simulation, or a digital image of a real industrial machine or the automation installation.

25. The method of claim 24, wherein the digital image is a digital twin.

26. The method of claim 15, wherein the computer-assisted safety test is carried out by an operator or automatically.

27. A computer program stored in an executable manner on a computer-readable data medium, the computer program comprising commands which, on execution of the computer program by an engineering platform, cause the engineering platform to carry out a method set forth in claim 15.

28. A machine-readable data storage medium comprising a computer program set forth in claim 27.

29. A data stream which carries a computer program set forth in claim 27.

30. An engineering platform, comprising a computer program set forth in claim 27.
